(19) United States
(12) Patent Application Publication
(10) Pub. No.: US 2011/0219925 A1
(43) Pub. Date: Sep. 15, 2011

(54) FLUID JET CUTTING ASSEMBLY AND METHOD FOR CUTTING A HOLLOW WORKPIECE

(76) Inventor: Narendra M. Singh, Edmonton (CA)

(21) Appl. No.: 12/817,589

(22) Filed: Jun. 17, 2010

Related U.S. Application Data
(60) Provisional application No. 61/187,833, filed on Jun. 17, 2009.

(51) Int. Cl. B26F 3/00

(52) U.S. Cl. 83/53; 83/177

(57) ABSTRACT

One embodiment of a fluid jet cutting assembly for cutting slots in a hollow workpiece, which may have an inner surface and an outer surface, may include a base. The assembly may also have an attachment mechanism supported by the base. The attachment mechanism may engage and support the workpiece. In addition, the assembly may also have a carrier supported by the base whereby the carrier or the attachment mechanism may be movable on the base along a longitudinal axis. Further, the assembly may have an array of fluid jet cutters extending from the carrier for cutting the hollow workpiece from the inner surface to the outer surface. The cutters may cut the slots in the workpiece in response to the carrier or the attachment mechanism moving along the longitudinal axis.

### CROSS REFERENCE TO RELATED APPLICATION

This application claims the benefit of U.S. Provisional Application No. 61/187,833 filed on Jun. 17, 2009, the disclosure of which is incorporated by reference.

### FIELD OF THE DISCLOSURE

The present disclosure generally relates to slotted liners for steam assisted gravity drainage (“SAGD”) oil recovery, and more particularly to a fluid jet cutting assembly and method for cutting a hollow workpiece.

### BACKGROUND OF THE DISCLOSURE

Oilfield service companies may use SAGD to extract heavy crude oil or bitumen from oil sands that are below conventional open pit mining depths. The SAGD process may include drilling two horizontal parallel wells into the oil sands, with one well drilled about five meters above the other. Each well may receive a slotted and seamed liner, which in one form may be a metal conduit having an inner surface, an outer surface and a series of keystone slots that taper from the inner surface to the outer surface. During oil recovery, high temperature steam may be continuously pumped through the top liner and into the bitumen to reduce its viscosity. This may permit gravity and a pressure differential to drain a mixture of the heated oil and water through the keystone slots into the bottom liner so that the mixture may be pumped through a pump line to a SAGD facility on the surface. The narrower width of the keystone slots on the outer surface of the liner may reduce the amount of sand entering into the bottom liner.

Liner manufacturers typically utilize high speed circular saws to cut slots into a casing or pipe from its outer surface to its inner surface. Each slot may have a generally constant width from the outer surface to the inner surface and a length that tapers from the outer surface to the inner surface. Furthermore, the slotted pipe may have wickers and burrs adjacent to each slot. The slotted pipe may then be processed at a cleaning station to remove the wickers and burrs. Then, the cleaned pipe may be taken to a seaming station where the slots are seamed to a predetermined outer diameter width thereby forming the keystone slots.

### SUMMARY OF THE DISCLOSURE

One embodiment of a fluid jet cutting assembly for cutting slots in a hollow workpiece, which may have an inner surface and an outer surface, may include a base. The assembly may also have an attachment mechanism supported by the base. The attachment mechanism may engage and support the workpiece. In addition, the assembly may also have a carrier supported by the base whereby the carrier or the attachment mechanism may be movable on the base along a longitudinal axis. Furthermore, the assembly may have an array of fluid jet cutters extending from the carrier for cutting the hollow workpiece from the inner surface to the outer surface. The cutters may cut the slots in the workpiece in response to the carrier or the attachment mechanism moving along the longitudinal axis.

One embodiment of a fluid jet cutting system for cutting slots in a workpiece, which may define a passage along a longitudinal axis, may include a base. The assembly may also have an attachment mechanism supported by the base. The attachment mechanism may engage and support the workpiece. In addition, the assembly may also have a carrier supported by the base whereby the carrier or the attachment mechanism may be movable on the base along a longitudinal axis. Furthermore, the assembly may have an array of fluid jet cutters extending from the carrier for cutting the hollow workpiece from within the passage. The cutters may cut the slots in the workpiece in response to the carrier or the attachment mechanism moving along the longitudinal axis. The system may also have a drive mechanism having a motor that may engage the carrier or the attachment mechanism for movement along the longitudinal axis, and the drive mechanism may also have a controller for generating a plurality of signals to induce the motor to engage the carrier or the attachment mechanism.

One embodiment of a method for cutting slots in a hollow workpiece having an outer surface and an inner surface that defines a passage, may include supporting the hollow workpiece on an attachment mechanism. The method may also include supporting an array of fluid jet cutters on a cattier such that the cutters may be disposed in the passage of the workpiece. The method may also include inducing the cutters to cut the workpiece from its inner surface to its outer surface. Furthermore, the method may include moving the attachment mechanism or the carrier along a longitudinal axis to cut the slots in the workpiece.

### BRIEF DESCRIPTION OF THE DRAWINGS

The advantages and features of the present disclosure will become better understood with reference to the following detailed description and claims taken in conjunction with the accompanying drawing, in which:

FIG. 1 is a diagram of one embodiment of a fluid jet cutting system having a fluid jet cutting assembly that includes cutters movable along a longitudinal axis for cutting slots in a hollow workpiece;

FIG. 2 is a perspective view of one embodiment of the fluid jet cutting assembly of FIG. 1;

FIG. 3 is a flow chart for one embodiment of a method for cutting a hollow workpiece;

FIG. 4 is a perspective view of another embodiment of a fluid jet cutting system having a fluid jet cutting assembly for moving a workpiece along a longitudinal axis to cut slots in the workpiece;

FIG. 5 is a perspective view of the assembly of FIG. 5; and

FIG. 6 is a flow chart for another embodiment of a method for cutting a hollow workpiece.

Like reference numerals refer to like parts throughout the description of several views of the drawings.

### DETAILED DESCRIPTION OF THE DISCLOSURE

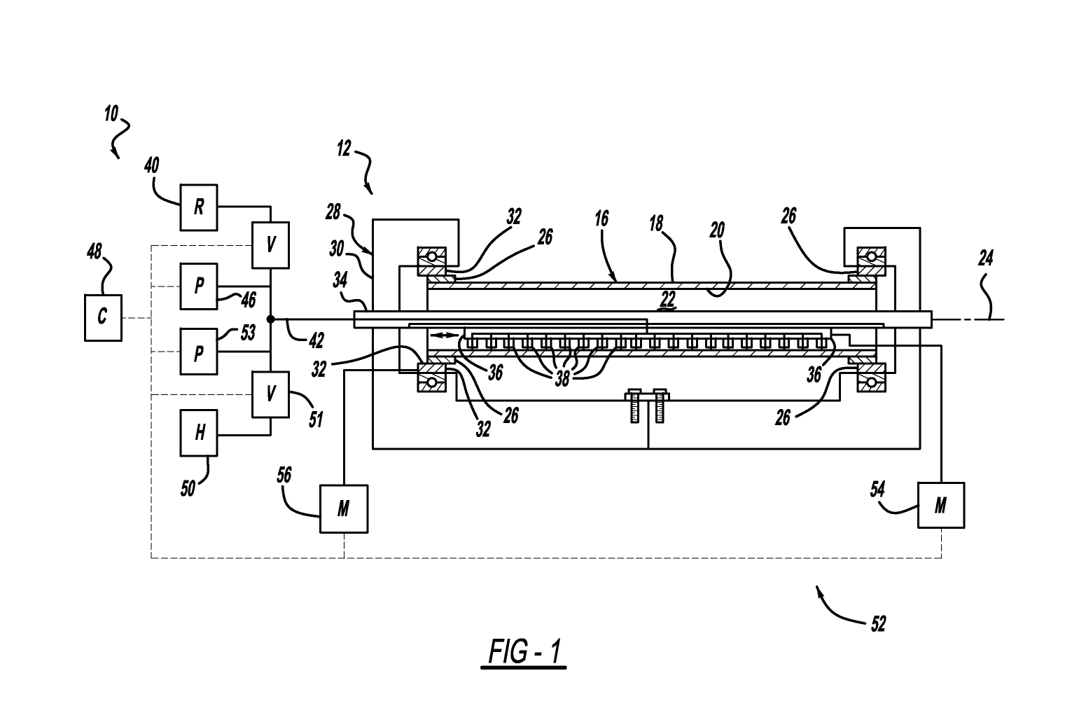

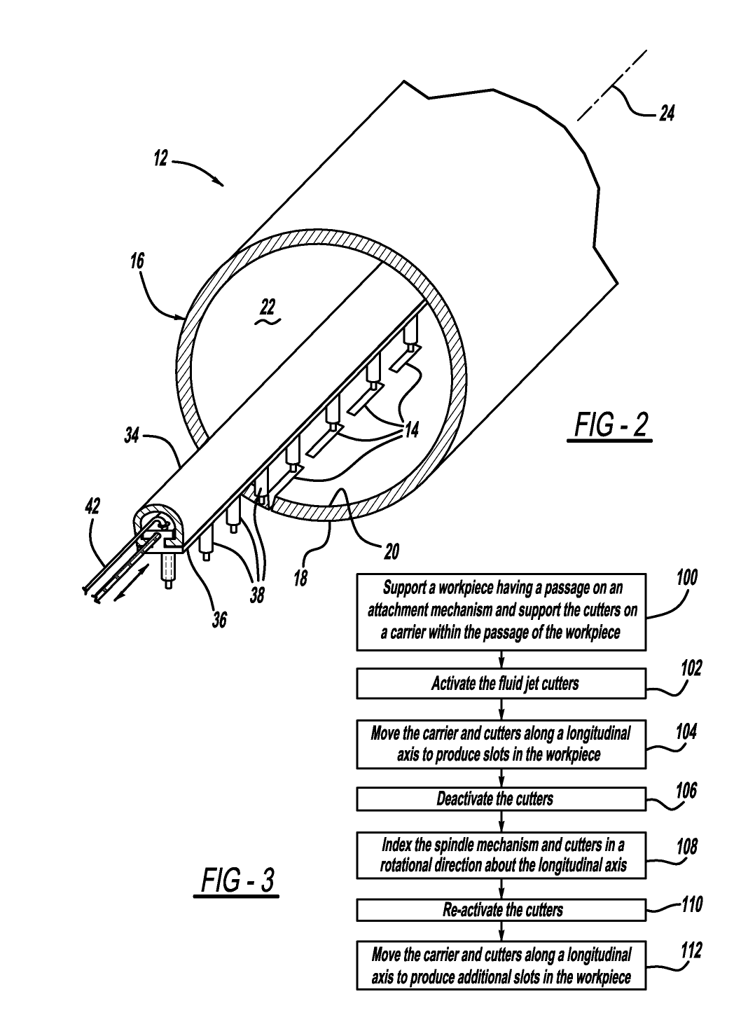

Referring to FIGS. 1 and 2, one embodiment of a fluid jet cutting system 10 (“system”) may have a fluid jet cutting assembly 12 (“assembly”) for cutting slots 14 (FIG. 2) in a hollow workpiece 16 to produce, for example, a slotted liner for SAGD wells. The workpiece 16 may be a casing or conduit having an outer surface 18 and an inner surface 20 that defines a passage 22 along a longitudinal axis 24.

The assembly 12 may have an attachment mechanism 26 for engaging and supporting the workpiece 16. The attachment mechanism 26 may be a pair of clamps adapted to hold opposing ends of the workpiece 16 or may be other suitable fasteners attached to any portion of the workpiece 16.

The assembly 12 may also have a base 28 that may support the attachment mechanism 26. The base 28 in this form may include a body 30 and a spindle mechanism 32 rotatably carried by the body 30. The spindle mechanism 32 may be adapted to index or pivot the attachment mechanism 26 and workpiece 16 in a rotational direction about the longitudinal axis 24. The spindle mechanism 32 may be a chuck, hub or any suitable rotary mechanism with ball bearings or other rotatable couplings. Furthermore, the base 28 may also have a shaft 34, which may extend from the body 30 and may be received within the passage 22 of the workpiece 16.

The assembly 12 may also have a carrier 36 or carriage, which in this form may be supported by the shaft 34 for movement along the longitudinal axis 24. The carrier 36 in this form may be a bracket slidably carried by the shaft 34 by a tongue in groove attachment, bushing or other slidable couplings. Of course, the carrier 36 may be a plate, a shuttle or other carriers that may be slidably mounted to any portion of the base 28. Further, it is contemplated that the carrier 36 may instead be held in one fixed position on the shaft, which may in turn be slidably carried by the base.

As best shown in FIG. 2, the assembly 12 may also have an array of fluid jet cutters 38 that may be carried by the carrier 36. The cutters 38 may be disposed in the passage 22 of the workpiece 16 for cutting the workpiece 16 from its inner surface 20 to its outer surface 18. The cutters 38 in one form may be 18 to 24 conventional waterjet cutting nozzles or any number of suitable cutters. The cutters 38 may also be directed toward one radial direction from the longitudinal axis 24. For example, each cutter may be directed downward from the shaft 34. Furthermore, the cutters 38 may be arranged in a predetermined pattern with respect to each other by, for example, spacing them apart from each other by a generally uniform distance along the longitudinal axis 24. For example, the cutters 38 may be uniformly spaced 6 inches to 2 feet apart from each other along the longitudinal axis. Of course, the cutters may be uniformly spaced apart from each other by more or less than 6 inches to 2 feet or unevenly spaced apart from each other as dictated by design requirements of the workpiece.

Referring to FIG. 1, the assembly 12 may also have a reservoir 40 for containing fluid, such as water, and a line 42 or conduit that may be communicated between the reservoir 40 and the cutters 38. The line 42 may include a valve 44, such as a solenoid valve, for selectively fluid from the reservoir 40 to the cutters 38. Further, the assembly 12 may include a pump 46 that may be connected to the line 42, such that the pump 46 may pump fluid from the reservoir 40 through the line 42 to the cutters 38 at a predetermined pressure. It is further contemplated that the assembly 12 may have an abrasive garnet hopper 50 or container, which may be used for storing an abrasive garnet. The hopper 50 may be communicated with a valve 51, which may in turn be communicated with the line 42. The assembly 12 may also have a pump 53 for pumping the abrasive garnet from the hopper 50 into the line 42.

The system 10 may also have a drive mechanism 52 that may engage the carrier 36 for movement along the longitudinal axis 24. The drive mechanism 52 in one form may be a CNC control system (“CNC system”). The CNC system may have a stepper motor 54 that engages the carrier 36 for moving the carrier 36 along the longitudinal axis 24. Of course, the CNC system may instead have a servo motor or other suitable motors. The CNC system may also include a controller 48 that may be operably associated with the motor 54 for generating a plurality of signals to induce the motor 54 to move the carrier 36 and cutters 38 thereon. In addition, the CNC system may include another motor 56 that engages the spindle mechanism 32 for indexing the spindle mechanism and the workpiece 16 in the rotational direction. The controller 48 may be operably associated with the motor 56 and generate a plurality of signals to induce the motor 56 to rotate the spindle mechanism 32 and workpiece 16.

Referring to FIG. 3, one embodiment of a method for operating the system 10 of FIGS. 1 and 2 to cut slots in the workpiece 16 will be explained.

At step 100, the workpiece 16 may be supported on the attachment mechanism 26, and the cutters 38 may be supported on the carrier 36 within the passage 22 of the workpiece 16.

Next at step 102, the controller 48 may generate a first plurality of signals to activate the cutters 38. For example, the first plurality of signals may induce the valve 44 to open and to further induce the pump 46 to pump fluid into the line 42. The signals may also induce the valve 51 to open and further induce the pump 53 to pump abrasive garnet into the line 42, such that the mixture of fluid and garnet is expelled through the cutters 38 toward the workpiece 16 in order to cut the workpiece 16 from its inner surface 20 to its outer surface 18. However, the valves and/or the pumps may be manually operated to activate the cutters as desired.

Next at step 104, the controller 48 may generate a second plurality of signals to induce the motor 54 to move the carrier 36 and cutters 38 by, for example, 6 inches to 2 feet along the longitudinal axis 24 while the cutters 38 expel the fluid. Of course, the motor 54 may instead move the carrier 36 by any suitable distance and/or in response to manual operation. This step may permit the cutters to produce slots that have a length generally equal to the distance that the carrier traveled. Furthermore, this step may produce the total number of desired slots along this portion of the workpiece, depending on the design requirements of the workpiece, the number of cutters and their respective positions along the workpiece.

Next at step 106, the controller 48 may generate a third plurality of signals to deactivate the cutters 38. For example, the third plurality of actuation signals may induce the pump 46 to stop pumping the fluid through the cutters 38 and further induce the valve 44 in the line 42 to close. The signals may also induce the valve 51 to close and further induce the pump 53 to stop pumping abrasive garnet into the line 42. However, the valve and/or the pump may be manually operated to deactivate the cutters as desired.

Next at step 108, the controller 48 may generate a fourth plurality of signals to induce the motor 56 to index or pivot the spindle mechanism 32 by, for example, 8 to 90 degrees, such that the cutters 38 may be directed toward another portion of the workpiece 16. Of course, the motor 56 may instead index the spindle mechanism 32 in response to manual operation and/or by any number of degrees as dictated by design requirements of the workpiece.

Next at step 110, the controller 48 may generate a fifth plurality of signals to reactivate the array of fluid jet cutters. The fifth plurality of signals may induce the valve 44 to re-open and further induce the pump 46 to pump fluid into the line 42. The signals may also induce the valve 51 to re-open and further induce the pump 53 to pump abrasive garnet into the line 42, such that the mixture of fluid and garnet is expelled through the cutters 38 to cut the workpiece 16 from its inner surface 20 to its outer surface 18. However, the valves and/or the pumps may be manually operated to activate the cutters.

Next at step 112, the controller 48 may generate a sixth plurality of signals to induce the motor 54 to move the carrier 36 by, for example, 6 inches to 2 feet along the longitudinal axis 24 to cut additional slots in the workpiece 16. However, the motor 54 may instead move the carrier 36 by any suitable distance and/or in response to manual operation.

The system and method of using fluid jets to cut a workpiece from its inner surface toward its outer surface may produce, for example, a slotted liner with keystone slots in one manufacturing station, as compared to three or more manufacturing stations being used to produce conventional slotted liners with keystone slots. In addition, the system and method may reduce the length of slots thereby increasing the strength of the slotted liners.

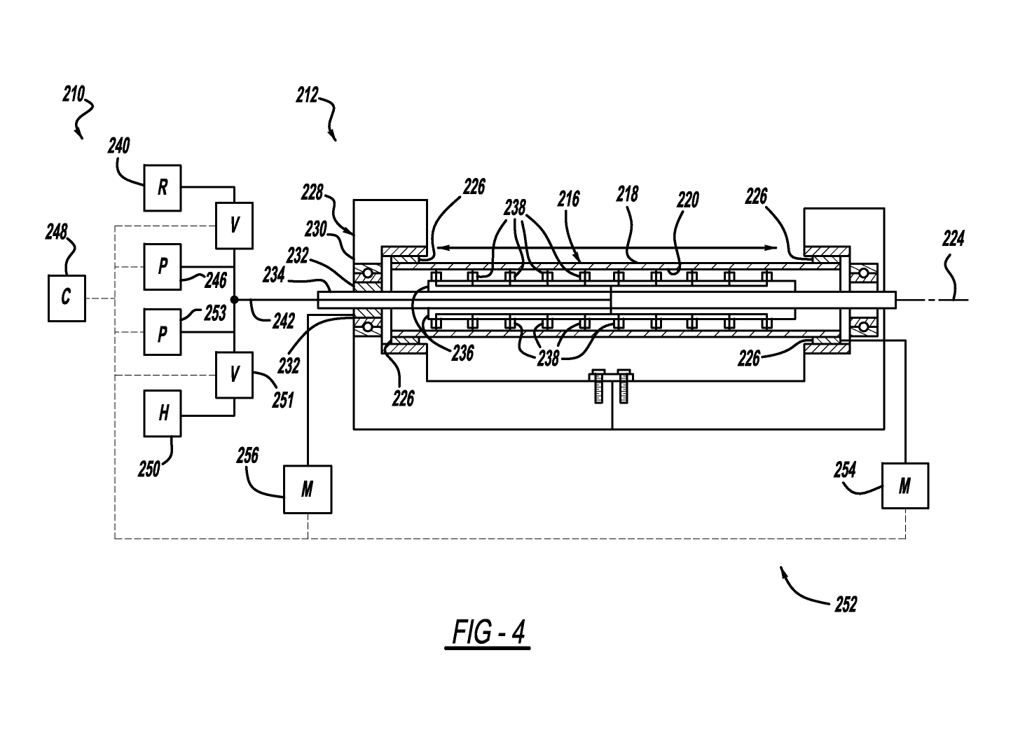

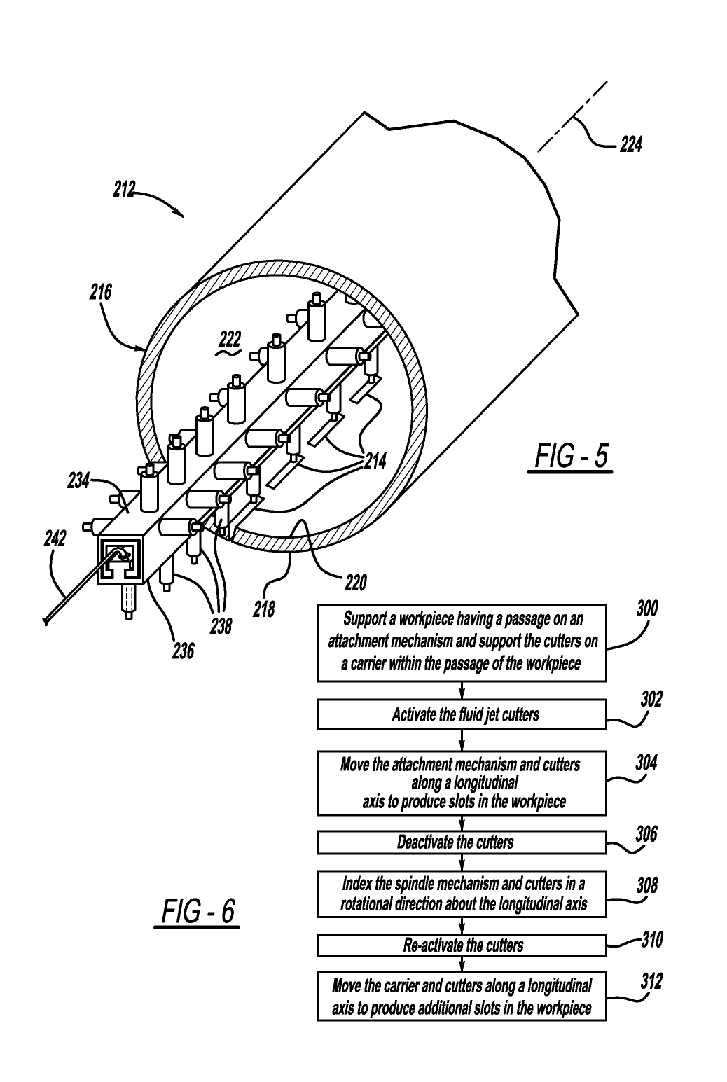

Referring now to FIGS. 4 and 5, another embodiment of a fluid jet cutting system 210 having a fluid jet cutting assembly 212 (“assembly”) may be substantially similar to the system 10 and assembly 12 of FIGS. 1 and 2. However, the assembly 212 may include an attachment mechanism 226 that may engage and support the workpiece 216 for movement along the longitudinal axis 224, as compared to the attachment mechanism 26 of FIG. 2 holding the workpiece 16 in a fixed position along the longitudinal axis 24. The attachment mechanism 226 may be, for example, a pair of clamps adapted to hold opposing ends of the workpiece 216 and slidably carried by bushings or other suitable couplings on the body 230 along the axis 224. Furthermore, the assembly 212 may also have an array of cutters 238 that may remain in a fixed position along the longitudinal axis 224, as compared to the cutters 38 of FIG. 2 being carried by the carrier 36 for movement along the axis 24. For example, the cutters 238 may be carried by the carrier 236, which in turn may be attached to the shaft 234 in one stationary position thereby holding the cutters 238 in their respective fixed positions on the shaft 234. These cutters 238 may also be directed toward a plurality of radial directions in a staggered pattern along the axis 224, as compared to the cutters 38 of FIGS. 1 and 2 being directed toward one radial direction. In addition, the assembly 212 may also have a spindle mechanism 232 rotatably carried by the body 230 for supporting the shaft 234 and the carrier 236, which in turn carries the cutters 238, as compared to the spindle mechanism 32 of FIG. 2 that supports the attachment mechanism 26, which in turn carries the workpiece 16. The spindle mechanism 232 in this form may pivot the cutters 238 for directing them toward another portion of the workpiece 216 rather than pivoting the workpiece itself.

Referring to FIG. 6, one embodiment of a method for operating the system 210 of FIG. 4 to cut slots in the workpiece 216 will be explained.

At step 300, the workpiece 216 may be supported on the attachment mechanism 226, and the cutters 238 may be supported on the carrier 236 within the passage 222 of the workpiece 216.

Next at step 302, the controller 248 may generate a first plurality of signals to activate the cutters 238. For example, the first plurality of signals may induce the valve 244 to open and to further induce the pump 246 to pump fluid into the line 242. The signals may also induce the valve 251 to open and further induce the pump 253 to pump abrasive garnet into the line 242, such that the mixture of fluid and garnet is expelled through the cutters 238 toward the workpiece 216 in order to cut the workpiece 216 from its inner surface 220 to its outer surface 218. However, the valves and/or the pumps may be manually operated to activate the cutters as desired.

Next at step 304, the controller 248 may generate a second plurality of signals to induce the motor 236 to move the attachment mechanism 226 and the workpiece 216 attached thereto by, for example, 6 inches to 2 feet along the longitudinal axis 224 while the cutters 238 expel the fluid. Of course, the motor 236 may instead move the attachment mechanism 226 by any suitable distance and/or in response to manual operation. This step may permit the cutters 236 to produce slots that have a length generally equal to the distance that the carrier traveled. Furthermore, this step may produce the total number of desired slots along this portion of the workpiece, depending on the design requirements of the workpiece, the number of cutters and their respective positions along the workpiece.

Next at step 306, the controller 248 may generate a third plurality of signals to deactivate the cutters 238. For example, the third plurality of actuation signals may induce the pump 246 to stop pumping the fluid through the cutters 238 and further induce the valve 244 in the line 242 to close. The signals may also induce the valve 251 to close and further induce the pump 253 to stop pumping abrasive garnet into the line 242. However, the valve and/or the pump may be manually operated to deactivate the cutters as desired.

Next at step 308, the controller 248 may generate a fourth plurality of signals to induce the motor 256 to index the spindle mechanism 232 by, for example, 8 to 90 degrees, which may in turn index the shaft 234 and the carrier 236 such that the cutters 238 may be directed toward another portion of the workpiece 216. Of course, the motor 256 may instead pivot the spindle mechanism 232 in response to manual operation and/or by any number of degrees as dictated by design requirements of the workpiece.

Next at step 310, the controller 248 may generate a fifth plurality of signals to reactivate the array of fluid jet cutters. The fifth plurality of signals may induce the valve 244 to re-open and further induce the pump 246 to pump fluid into the line 242. The signals may also induce the valve 251 to open and further induce the pump 253 to pump abrasive garnet into the line 242, such that the mixture of fluid and garnet is expelled through the cutters 238 to cut the workpiece 216 from its inner surface 220 to its outer surface 218. However, the valve and/or the pump may be manually operated to activate the cutters.

Next at step 312, the controller 248 may generate a sixth plurality of signals to induce the motor 236 to move the attachment mechanism 226 and workpiece 316 by, for example, 6 inches to 2 feet along the longitudinal axis 224 to cut additional slots in the workpiece 216. However, the motor 236 may instead move the attachment mechanism 26 by any suitable distance and/or in response to manual operation.

The exemplary embodiments described herein detail for illustrative purposes are subject to many variations in structure and design. It should be emphasized, however, that the present disclosure is not limited to a system and method for manufacturing slotted liners for SAGD oil recovery as shown and described. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A fluid jet cutting assembly for cutting slots in a hollow workpiece having an inner surface and an outer surface, the fluid jet cutting assembly comprising:
a base;
an attachment mechanism supported by the base, the attachment mechanism for engaging and supporting the workpiece;
a carrier supported by the base whereby one of the carrier and the attachment mechanism and is movable on the base along a longitudinal axis; and
an array of fluid jet cutters extending from the carrier for cutting the hollow workpiece from the inner surface to the outer surface, and the array of fluid jet cutters cutting the slots in the hollow workpiece in response to one of the attachment mechanism and the carrier moving along the longitudinal axis.

2. The fluid jet cutting assembly of claim 1, wherein the base has a body and a shaft extending from the body whereby the shaft is received within the hollow workpiece and supports the carrier for movement along the longitudinal axis.

3. The fluid jet cutting assembly of claim 2, wherein the carrier is slidably carried on the shaft.

4. The fluid jet cutting assembly of claim 2, wherein the attachment mechanism is slidably carried by the base.

5. The fluid jet cutting assembly of claim 2, wherein the base includes a spindle mechanism rotatably carried by the body, whereby the spindle mechanism supports the attachment mechanism for pivoting in the rotational direction about the longitudinal axis.

6. The fluid jet cutting assembly of claim 2, wherein the base further includes a spindle mechanism rotatably carried by the body, whereby the spindle mechanism supports the shaft for pivoting in the rotational direction about the longitudinal axis.

7. A fluid jet cutting system for cutting slots in a workpiece that defines a passage along a longitudinal axis, the fluid jet cutting system comprising:
a base;
an attachment mechanism supported by the base, the attachment mechanism for engaging and supporting the workpiece;
a carrier supported by the base whereby one of the carrier and the attachment mechanism and is movable on the base along a longitudinal axis;
an array of fluid jet cutters extending from the carrier and disposed within the passage for cutting the hollow workpiece from the inner surface to the outer surface, and the array of fluid jet cutters cutting the slots in the hollow workpiece in response to one of the attachment mechanism and the carrier moving along the longitudinal axis; and
a drive mechanism having a motor that engages one of the carrier and the attachment mechanism for movement along a longitudinal axis such that the array of fluid jet cutters cuts the slots in the hollow workpiece, and the drive mechanism also having a controller for generating a plurality of signals to induce the motor to engage one of the carrier and the attachment mechanism.

8. The fluid jet cutting system of claim 7, wherein the array of fluid jet cutters are spaced apart from each other along the longitudinal axis.

9. The fluid jet cutting system of claim 7, wherein the array of fluid jet cutters are directed toward one radial direction from the longitudinal axis.

10. The fluid jet cutting system of claim 7, wherein the array of fluid jet cutters are directed toward a plurality of radial directions.

11. The fluid jet cutting system of claim 7, further comprising:
a reservoir containing fluid;
a conduit in communication between the reservoir and the array of fluid jet cutters; and
a pump connected to one of the reservoir and the conduit for pumping fluid to the array of fluid jet cutters.

12. A method for cutting slots in a hollow workpiece having an outer surface and an inner surface that defines a passage, the method comprising:
supporting the hollow workpiece on an attachment mechanism;
supporting an array of fluid jet cutters on a carrier such that the array of fluid jet cutters are disposed in the passage of the hollow workpiece;
inducing the array of fluid jet cutters to cut the hollow workpiece from the inner surface to the outer surface; and
moving one of the attachment mechanism and the carrier along a longitudinal axis to cut the slots in the hollow workpiece.

13. The method of claim 12, further comprising pivoting one of the hollow workpiece and the array of fluid jet cutters in a rotational direction about the longitudinal axis.

14. The method of claim 12, further comprising a controller operably associated with at least one of the array of fluid jet cutters, a motor, a pump and a valve.

15. The method of claim 12, further comprising generating a first plurality of signals to activate the array of fluid jet cutters.

16. The method of claim 12, further comprising generating a second plurality of signals to induce a motor to move the carrier along the longitudinal axis while the array of fluid jet cutters expel fluid.

17. The method of claim 12, further comprising generating a third plurality of signals to deactivate the array of fluid jet cutters.

18. The method of claim 12, further comprising generating a fourth plurality of signals to induce a motor to pivot a spindle mechanism, such that the array of fluid jet cutters are directed toward another portion of the workpiece.

19. The method of claim 12, further comprising generating a fifth plurality of signals to reactivate the array of fluid jet cutters.
